(19) United States
(12) Patent Application Publication
(10) Pub. No.: US 2026/0369237 A1
(43) Pub. Date: Nov. 19, 2026

(54) RECEIVER AND DISPLAY DRIVING DEVICE HAVING THE SAME

(71) Applicant: LX SEMICON CO., LTD., Daejeon (KR)

(72) Inventors: SEOK JAE OH, Daejeon (KR); MYUNG YU KIM, Daejeon (KR); Chung-Jae LEE, Daejeon (KR); JUNG HWAN CHOI, Daejeon (KR)

(73) Assignee: LX SEMICON CO., LTD., Daejeon (KR)

(21) Appl. No.: 19/681,884

(22) Filed: May 19, 2026

(30) Foreign Application Priority Data
May 19, 2025 (KR) 10-2025-0064753

(51) Int. Cl. G09G 3/3275; G09G 3/32

(52) U.S. Cl. CPC G09G 3/3275; G09G 3/32; G09G 2310/0275; G09G 2320/041

(57) ABSTRACT

The receiver according to one embodiment of the present disclosure may include a continuous time linear equalizer and an amplifier that compensate for and amplify an input received signal and output the received signal and whose gain decreases according to temperature, a reference current generation unit that generates a reference current and provides the reference current as a bias current of the continuous time linear equalizer and the amplifier, and a temperature sensor that generates a temperature proportional voltage using a temperature proportional current source and senses a temperature change by comparing the temperature proportional voltage with a plurality of reference voltages, wherein the reference current generation unit may be configured to adjust the reference current in response to a temperature compensation code from the temperature sensor.

### CROSS-REFERENCE TO RELATED APPLICATION

This application claims priority to and the benefit of Korean Patent Application No. 10-2025-0064753, filed on May 19, 2025, the entire contents of which are hereby incorporated by reference in its entirety as if fully set forth herein.

### BACKGROUND

### Field of the Invention

The present disclosure relates to a receiver capable of temperature compensation and a display driving device having the same.

### Discussion of the Related Art

In a display driving device, a data driving circuit (or a source driving circuit) may receive digital image data from a timing controller, convert the digital image data into an analog data voltage, and supply the analog data voltage to a display panel.

The timing controller and the data driving circuit may transmit and receive image data and various types of control information through a high-speed serial interface.

In the data driving circuit, the receiver may compensate for transmission line loss of a received signal using an equalizer.

In the receiver, as an amplifier and an equalizer include a transistor whose mobility changes according to temperature changes, characteristics may fluctuate with temperature changes and thus compensation performance may be degraded. Accordingly, in the data driving circuit, since restoration quality of the received signal is degraded, reliability may decrease.

### SUMMARY

The present disclosure is directed to providing a receiver capable of maintaining constant compensation performance and stably compensating for a received signal even in temperature changes, and a display driving device having the same.

A receiver according to one embodiment of the present disclosure includes a continuous time linear equalizer and an amplifier that compensate for and amplify an input received signal and output the received signal and whose gain decreases according to temperature, a reference current generation unit that generates a reference current and provides the reference current as a bias current of the continuous time linear equalizer and the amplifier, and a temperature sensor that generates a temperature proportional voltage using a temperature proportional current source and senses a temperature change by comparing the temperature proportional voltage with a plurality of reference voltages, wherein the reference current generation unit adjusts the reference current in response to a temperature compensation code from the temperature sensor.

In the receiver according to one embodiment of the present disclosure, the reference current generation unit may be configured to increase the reference current in response to the temperature compensation code as the temperature sensed by the temperature sensor increases.

In the receiver according to one embodiment of the present disclosure, the reference current generation unit may be configured to increase the gain of the continuous time linear equalizer and the amplifier in response to the temperature compensation code as the temperature sensed by the temperature sensor increases.

In the receiver according to one embodiment of the present disclosure, the temperature sensor may include a temperature proportional voltage generation unit configured to generate the temperature proportional voltage using the temperature proportional current source, a reference voltage generation unit configured to generate a plurality of different reference voltages corresponding to each of a plurality of different reference temperatures using a fixed current source, a comparison unit including a plurality of comparators configured to respectively compare the temperature proportional voltage with the plurality of reference voltages and output the comparison result, and an encoder configured to encode the comparison result of the plurality of comparators and output the temperature compensation code.

The receiver according to one embodiment of the present disclosure may include a plurality of gain curves separated from each other based on each of the reference temperatures, wherein each of the plurality of gain curves may have a form in which a corresponding gain decreases as a temperature belonging to a corresponding temperature range increases.

In the receiver according to one embodiment of the present disclosure, the plurality of reference voltages may decrease as the plurality of reference temperatures increase.

A data driving circuit according to one embodiment of the present disclosure includes the receiver.

A display driving device according to one embodiment of the present disclosure includes a timing controller that transmits a transmission packet including a clock training pattern, configuration information, and image data, and first and second data driving circuits that receive the transmission packet from the timing controller and recover and use a clock signal, the configuration information, and the image data from a received signal, wherein the timing controller further includes a temperature sensor that senses a temperature, generates a temperature compensation code from an output of the temperature sensor, includes the temperature compensation code in the configuration information, and transmits the temperature compensation code to each of the first and second data driving circuits, and a receiver of each of the first and second data driving circuits is configured to compensate for a gain of the receiver in response to the temperature compensation code included in the configuration information.

In the display driving device according to one embodiment of the present disclosure, the receiver may include a continuous time linear equalizer and an amplifier configured to compensate for and amplify the received signal and output the received signal, and allow the gain to decrease according to temperature, and a reference current generation unit configured to generate a reference current and provide the reference current as a bias current of the continuous time linear equalizer and the amplifier, and the reference current generation unit may be configured to adjust the reference current in response to the temperature compensation code.

In the display driving device according to one embodiment of the present disclosure, the timing controller may include the temperature compensation code in the configuration information and transmit the temperature compensation code for each period of each row line during a vertical active period of each frame.

A display driving device according to one embodiment of the present disclosure includes a timing controller that transmits a transmission packet including a clock training pattern, configuration information, and image data, and a data driving circuit that receives the transmission packet from the timing controller and recovers and uses a clock signal, the configuration information, and the image data from a received signal, wherein the data driving circuit further includes a temperature sensor that senses a temperature, and transmits sensing data of the temperature sensor to the timing controller through an auxiliary channel, the timing controller generates a temperature compensation code from the sensing data, includes the temperature compensation code in the configuration information, and transmits the temperature compensation code to the data driving circuit, and a receiver of the data driving circuit is configured to compensate for a gain of the receiver in response to the temperature compensation code included in the configuration information.

In the display driving device according to one embodiment of the present disclosure, the receiver may include a continuous time linear equalizer and an amplifier configured to compensate for and amplify the received signal and output the received signal, and allow the gain to decrease according to temperature, a reference current generation unit configured to generate a reference current and provide the reference current as a bias current of the continuous time linear equalizer and the amplifier, and the reference current generation unit may be configured to adjust the reference current in response to the temperature compensation code.

In the display driving device according to one embodiment of the present disclosure, the data driving circuit may enable the temperature sensor during one row line period during a vertical active period of each frame to generate the sensing data, and transmit the sensing data to the timing controller during a vertical blank period of each frame.

In the display driving device according to one embodiment of the present disclosure, the timing controller may include the temperature compensation code in the configuration information and transmit the temperature compensation code for each period of each row line during a vertical active period of each frame.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a block diagram schematically showing a configuration of a data driving circuit in a display driving device according to one embodiment of the present disclosure;

FIG. 2 is a block diagram schematically showing an internal configuration of a serial-to-parallel converter according to one embodiment of the present disclosure;

FIG. 3 is an equivalent circuit diagram illustrating a detailed configuration of a receiver having a temperature sensor according to one embodiment of the present disclosure;

FIG. 4 is an equivalent circuit diagram illustrating a detailed configuration of the temperature sensor according to one embodiment of the present disclosure;

FIG. 5 is a graph illustrating a temperature-gain relationship of an amplifier according to one embodiment of the disclosure;

FIG. 6 is a graph illustrating the frequency response characteristics and temperature relationship of a continuous time linear equalizer according to one embodiment of the present disclosure;

FIG. 7 is a graph illustrating a temperature-resistance change rate of a P+ poly resistor in a temperature proportional voltage generation unit according to one embodiment of the present disclosure for each process;

FIG. 8 is a graph illustrating a temperature-current relationship of the temperature proportional voltage generation unit according to one embodiment of the present disclosure;

FIGS. 9A and 9B are graphs illustrating a comparison of gain curves before and after compensation of a receiver circuit according to a comparative example and one embodiment of the present disclosure;

FIG. 10 is a graph illustrating a comparison of gain curves of a receiver according to the comparative example and one embodiment of the present disclosure;

FIG. 11 is a block diagram schematically showing the display driving device according to one embodiment of the present disclosure;

FIG. 12 is a waveform diagram illustrating a transmission packet of the display driving device according to one embodiment of the present disclosure;

FIG. 13 is a view illustrating a data format of the display driving device according to one embodiment of the present disclosure;

FIG. 14 is a flowchart illustrating a temperature compensation method of the display driving device according to one embodiment of the present disclosure;

FIG. 15 is a block diagram schematically showing a display driving device according to one embodiment of the present disclosure;

FIG. 16 is a waveform diagram illustrating a transmission packet of the display driving device according to one embodiment of the present disclosure; and

FIG. 17 is a flowchart illustrating a temperature compensation method of the display driving device according to one embodiment of the present disclosure.

### DETAILED DESCRIPTION OF THE DISCLOSURE

Advantages and features of the present disclosure and methods of achieving them will become apparent with reference to the following embodiments which are described in detail along with the accompanying drawings. However, the present disclosure is not limited to the embodiments to be described below and may be implemented in various different forms, the embodiments are only provided to completely disclose the present disclosure and completely convey the scope of the present disclosure to those skilled in the art, and the present disclosure is defined only by the scope of the claims.

The same reference number refers to the same components throughout the specification. Further, in describing the present disclosure, when it is determined that a detailed description of related known technology may unnecessarily obscure the gist of the present disclosure, the detailed description thereof will be omitted.

When ‘providing,’ ‘including,’ ‘having,’ ‘consisting of,’ and the like mentioned in the present specification are used, other parts may be added unless ‘only’ is used. A case in which a component is expressed in a singular form may include a plural form unless explicitly stated otherwise.

In interpreting a component, the component is interpreted as including a margin of error even when there is no separate explicit description of the margin of error.

In the case of a description of a positional relationship, for example, when the positional relationship of two parts is described as “on,” “at an upper portion,” “at a lower portion,” “next to,” “adjacent to,” or the like, one or more other parts may be located between the two parts unless “immediately,” “directly,” ‘or “close” is used.

In a description of a temporal relationship, when the temporal relationship is described as ‘after,’ in succession to,’ ‘and then,’ ‘before,’ or the like, non-consecutive cases may also be included unless ‘immediately’ or ‘directly’ is used.

Although first, second, and the like are used to describe various components, these components are not limited by these terms. These terms are only used to distinguish one component from another. Accordingly, a first component, which is mentioned below may also be a second component within the technical spirit of the present disclosure.

It should be understood that the term “at least one” includes all possible combinations from one or more related items. For example, the meaning of “at least one of the first, second, and third items” may mean any combination of items which may be proposed from two or more of the first item, the second item, and the third item, as well as each of the first item, the second item, or the third item.

Features of various embodiments of the present specification may be partially or entirely combined with each other, and technically, various linkages and operations are possible, and the embodiments may be implemented independently of each other or together in a related relationship.

Hereinafter, embodiments of the present disclosure will be described in detail with reference to the accompanying drawings. The scale of the components illustrated in the drawings is different from the actual scale for convenience of description, and thus is not limited to the scale illustrated in the drawings.

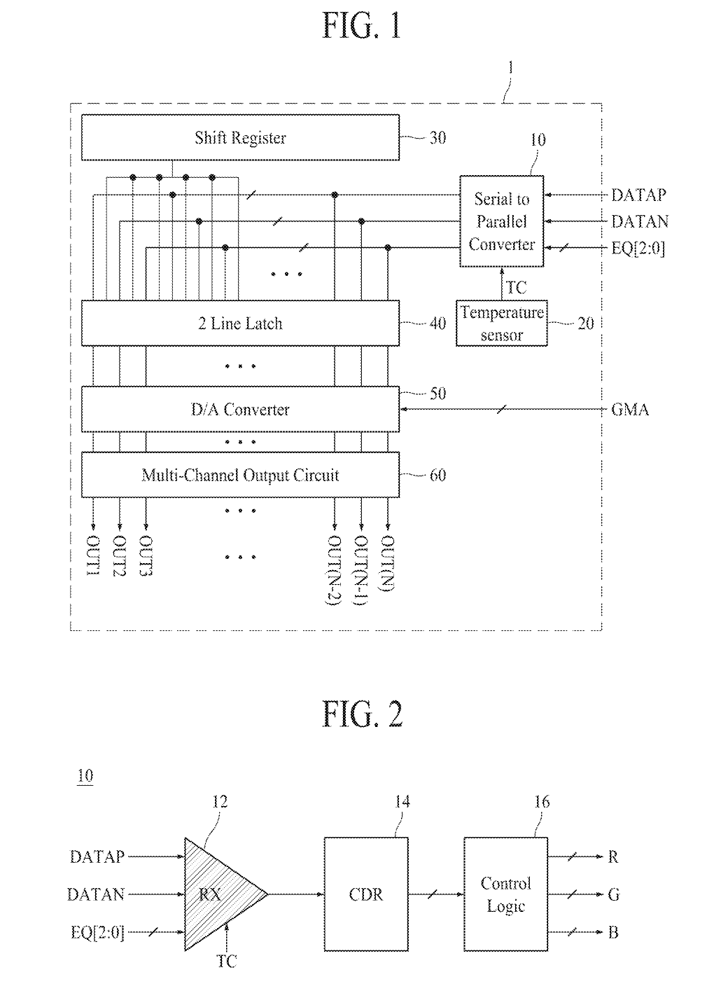

FIG. 1 is a block diagram schematically showing a configuration of a data driving circuit in a display driving device according to one embodiment of the present disclosure, and FIG. 2 is a block diagram schematically showing an internal configuration of a serial-to-parallel converter according to one embodiment of the present disclosure.

A display device to which the display driving device according to one embodiment of the present disclosure is applied may be any one of various display devices including a liquid crystal display device, an electroluminescent display device, a micro-light-emitting diode (LED) display device, and the like. The electroluminescent display device may be an organic light-emitting diode (OLED) display device, a quantum-dot light-emitting diode (QLED) display device, or an inorganic light-emitting diode (ILED) display device.

The display device may include a display panel which displays images through a pixel matrix, a gate driving circuit which is embedded in the display panel and drives gate lines of the pixel matrix, a data driving circuit which is connected to the display panel and drives data lines of the pixel matrix, a timing controller which controls the operation of the gate driving circuit and the data driving circuit, and a power management circuit which generates and supplies voltages required for driving the display device.

The data driving circuit and the timing controller may be expressed as the display driving device.

Referring to FIG. 1, a data driving circuit 1 according to one embodiment may include a serial-to-parallel converter 10, a shift register 30, a latch unit 40 including a 2-line latch unit, a digital-to-analog (D/A) converter 50, and a multi-channel output circuit 60. The data driving circuit 1 according to one embodiment may further include a temperature sensor 20.

The serial-to-parallel converter 10 may receive transmission signals DATAP/DATAN in the form of differential signals transmitted in a high-speed serial interface method through a transmission channel from the timing controller. The serial-to-parallel converter 10 may recover and output a clock signal, image data, and control signals from the received transmission signals DATAP/DATAN. The serial-to-parallel converter 10 may receive an equalizer setting value EQ[2:0] from the timing controller.

Referring to FIGS. 1 and 2, the serial-to-parallel converter 10 may include a receiver (RX) 12, a clock and data recovery unit (CDR) 14, and a control logic unit 16.

The receiver (RX) 12 may include an amplifier and a continuous time linear equalizer (CTLE), and the continuous time linear equalizer may set a gain according to the equalizer setting value EQ[2:0]. The receiver (RX) 12 may compensate for the loss of the received transmission signals DATAP/DATAN using the continuous time linear equalizer, and output the compensated signals to the clock data recovery unit (CDR) 14.

Particularly, the receiver (RX) 12 according to one embodiment may compensate for the temperature change characteristics (gain) by receiving a temperature compensation code TC from the temperature sensor 20 which detects the temperature change and a temperature proportional current (proportional to absolute temperature current, PTAT) source. Detailed description thereof will be described below.

In one embodiment, the temperature sensor 20 may be embedded in the data driving circuit 1 or the timing controller. In one embodiment, the temperature sensor 20 may be expressed as a temperature compensation circuit.

The receiver (RX) 12 according to one embodiment may minimize a fluctuation in the gain of the amplifier and the continuous time linear equalizer due to temperature changes by adjusting a reference current using the temperature compensation code TC from the temperature sensor 20. Accordingly, the receiver 12 may maintain constant compensation performance even in temperature changes.

The clock data recovery unit 14 may receive the compensated signals from the receiver 12 and recover the clock signal, image data, and various control signals and output the clock signal, the image data, and the various control signals to the control logic unit 16.

The control logic unit 16 may convert image data for each sub-pixel unit supplied from the clock data recovery unit 14 into parallel data R, G, and B and output the parallel data R, G, and B to the latch unit 40. The control logic unit 16 may output a source start pulse and a source shift clock to the shift register 30 using the clock signal and the control signals supplied from the clock data recovery unit 14, output a load signal (or a source output enable signal) to the latch unit 40 and the multi-channel output circuit 60, and output control signals required for the operation of other configurations of the data driving circuit 1.

The shift register 30 may sequentially output a plurality of sampling signals to the latch unit 40 while sequentially shifting the source start pulse according to the source shift clock.

The latch unit 40 may include a 2-line latch unit including a first line latch unit and a second line latch unit. The first line latch unit of the latch unit 40 may latch image data R, G, and B of a plurality of channels transmitted through a data bus from the control logic unit 16 of the serial-to-parallel converter 10 for each sub-pixel unit channel in response to the sampling signals from the shift register 30. The first line latch unit may sequentially latch the image data of all channels for a 1-row line, and then simultaneously output the latched image data of each channel to the second line latch unit. The second line latch unit may latch the image data of each channel (the sub-pixel) in response to the load signal from the control logic unit 16 and simultaneously output the latched image data to the D/A converter 50.

The D/A converter 50 may convert the image data of each sub-pixel supplied from the latch unit 40 into an analog data voltage for each channel using a plurality of gamma voltages GMA, and output the data voltage of each channel to the multi-channel output circuit 60.

The multi-channel output circuit 60 may include output buffers of the plurality of channels. The multi-channel output circuit 60 may buffer the multi-channel data voltages supplied from the D/A converter 50 for each channel, and output multi-channel data voltages OUT1–OUT(N) to the display panel.

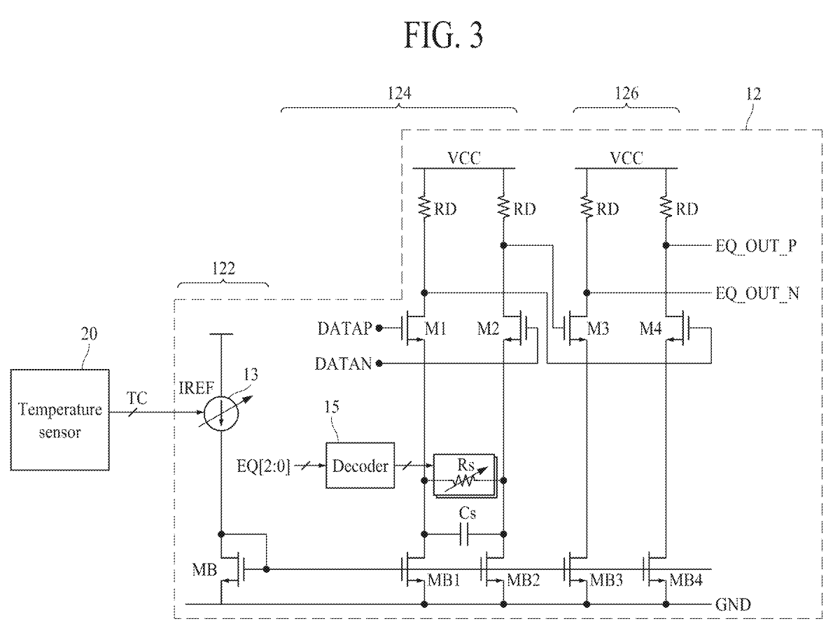

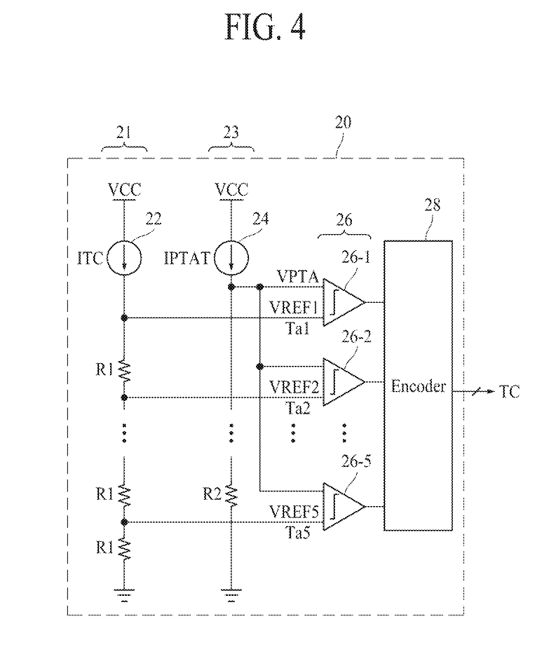

FIG. 3 is an equivalent circuit diagram illustrating a detailed configuration of the receiver having a temperature sensor according to one embodiment of the present disclosure, and FIG. 4 is an equivalent circuit diagram illustrating a detailed configuration of the temperature sensor according to one embodiment of the present disclosure.

Referring to FIG. 3, the receiver 12 according to one embodiment may include a continuous time linear equalizer (CTLE) 124, an amplifier 126, and a reference current generation unit 122. The reference current generation unit 122 may be connected to the temperature sensor 20 and may receive the temperature compensation code TC from the temperature sensor 20.

The continuous time linear equalizer 124 may include input N-type metal oxide semiconductor (NMOS) transistors M1 and M2 connected between a power supply voltage VCC and a ground voltage GND, resistors RD each connected between the power supply voltage VCC and drain electrodes of the input NMOS transistors M1 and M2, a variable resistor Rs and a variable capacitor Cs connected in parallel between source electrodes of the input NMOS transistors M1 and M2, and bias NMOS transistors MB1 and MB2 connected between the source electrodes of the input NMOS transistors M1 and M2 and the ground voltage GND. The continuous time linear equalizer 124 may further include a decoder 15 which decodes the equalizer setting value EQ[2:0] and outputs signals which control the variable resistor Rs and the variable capacitor Cs.

The input NMOS transistors M1 and M2 may amplify a current corresponding to the received signals DATAP and DATAN in response to the received signals DATAP and DATAN input to gate electrodes and output the current to the amplifier 126.

The variable resistor Rs and the variable capacitor Cs may adjust a resistance value of the variable resistor Rs and a capacitance of the variable capacitor Cs according to the equalizer setting value EQ[2:0] provided through the decoder 15. Accordingly, the continuous time linear equalizer 124 may compensate for transmission line loss of the received signals DATAP and DATAN by amplifying the current with a specific gain in a specific frequency band to be suitable for a high-speed interface.

The amplifier 126 may include output NMOS transistors M3 and M4 connected between the power supply voltage VCC and the ground voltage GND, resistors RD each connected between the power supply voltage VCC and drain electrodes of the output NMOS transistors M3 and M4, and bias NMOS transistors MB3 and MB4 connected between source electrodes of the output NMOS transistors M3 and M4 and the ground voltage GND.

A gate electrode of each of the output NMOS transistors M3 and M4 may be connected to the drain electrode of each of the input NMOS transistors M1 and M2, and the drain electrode of each of the output NMOS transistors M3 and M4 may be connected to an output node. The output NMOS transistors M3 and M4 of the amplifier 126 may amplify the received signals DATAP and DATAN and output output signals EQ_OUT_P and EQ_OUT_N through the output nodes in response to the current generated in the continuous time linear equalizer 124 corresponding to the received signals DATAP and DATAN.

The reference current generation unit 122 may generate a reference current IREF and mirror the reference current IREF to provide the reference current IREF as a bias current which drives the continuous time linear equalizer 124 and the amplifier 126. The reference current generation unit 122 may include a variable reference current source unit 122 and a bias NMOS transistor MB connected in series between the power supply voltage VCC and the ground voltage GND.

The variable reference current source 13 may generate the reference current IREF and adjust the reference current IREF according to the temperature compensation code TC from the temperature sensor 20.

The bias NMOS transistor MB may have a diode structure in which a drain electrode and a gate electrode are connected to the variable reference current source 13, and a source electrode may be connected to the ground voltage GND. The bias NMOS transistors MB and the bias NMOS transistors MB1 to MB4 of the continuous time linear equalizer 124 and the amplifier 126 may have a current mirror structure in which the gate electrodes are connected in common.

Referring to FIGS. 3 and 4, the temperature sensor 20 may generate the temperature compensation code TC and output the temperature compensation code TC to the variable reference current source 13.

The temperature sensor 20 according to one embodiment may include a reference voltage generation unit 21 which generates a plurality of reference voltages VREF1 to VREF5 using a fixed current ITC which does not vary according to temperature, a temperature proportional voltage generation unit 23 which generates a temperature proportional voltage VPTAT using a temperature proportional current (proportional to absolute temperature current) IPTAT which varies according to temperature, a comparison unit 26 which senses the temperature change by comparing the reference voltages VREF1 to VREF5 from the reference voltage generation unit 21 with the temperature proportional voltage VPTAT from the temperature proportional voltage generation unit 23, and an encoder 28 which encodes the output of the comparison unit and outputs the temperature compensation code TC.

The reference voltage generation unit 21 may include a fixed current source 22 and a plurality of resistors R1 connected in series between the power supply voltage VCC and the ground voltage GND. The fixed current source 22 may generate and output a fixed current ITC which does not vary according to temperature. The plurality of resistors R1 may output the plurality of reference voltages VREF1 to VREF5 by dividing the voltage generated by the fixed current ITC. The plurality of reference voltages VREF1 to VREF5 may each correspond to a plurality of different reference temperatures and may be inversely proportional to the plurality of reference temperatures. For example, the plurality of reference voltages VREF1 to VREF5 may each correspond to the plurality of reference temperatures (25° C, 50° C, 75° C, 100° C, and 125° C), and each correspond to a temperature-inversely proportional voltage which decreases as the reference temperatures (25° C, 50° C, 75° C, 100° C, and 125° C) increase. The number of reference voltages VREF1 to VREF5 may vary according to the plurality of reference temperatures.

The temperature proportional voltage generation unit 23 may include a temperature proportional current source 24 and a temperature variable resistor R2 connected in series between the power supply voltage VCC and the ground voltage GND. The temperature variable resistor R2 may be a P+ poly resistor and may have a characteristic in which resistance decreases in proportion to temperature. Accordingly, the temperature proportional current source 24 may generate and output the temperature proportional current IPTAT which increases in proportion to temperature, and as a result, output the temperature proportional voltage VPTAT which increases in proportion to temperature.

The comparison unit 26 may output a sensing result for a temperature change using a plurality of comparators 26-1 to 26-5 to compare the plurality of reference voltages VREF1 to VREF5 from the reference voltage generation unit 21 with the temperature proportional voltage VPTAT from the temperature proportional voltage generation unit 23 and output a comparison result which indicates a high logic or low logic.

The encoder 28 may encode the comparison result of each of the plurality of comparators 26-1 to 26-5 of the comparison unit 26 and output the temperature compensation code TC corresponding to the temperature sensing result to the variable reference current source 13.

Accordingly, the reference current generation unit 122 of the receiver 12 may adjust the reference current IREF according to the temperature compensation code TC from the temperature sensor 20 to provide the reference current IREF as a bias current which drives the continuous time linear equalizer 124 and the amplifier 126.

As the variable reference current generation unit 122 increases the reference current IREF to increase the bias current of the continuous time linear equalizer 124 and the amplifier 126 as the temperature increases in response to the temperature compensation code TC of the temperature sensor 20, a gain change according to a temperature change may be suppressed or minimized by compensating for gain reduction.

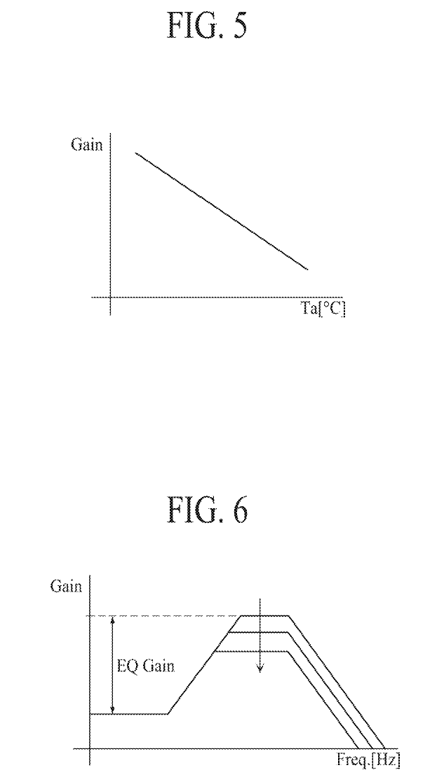

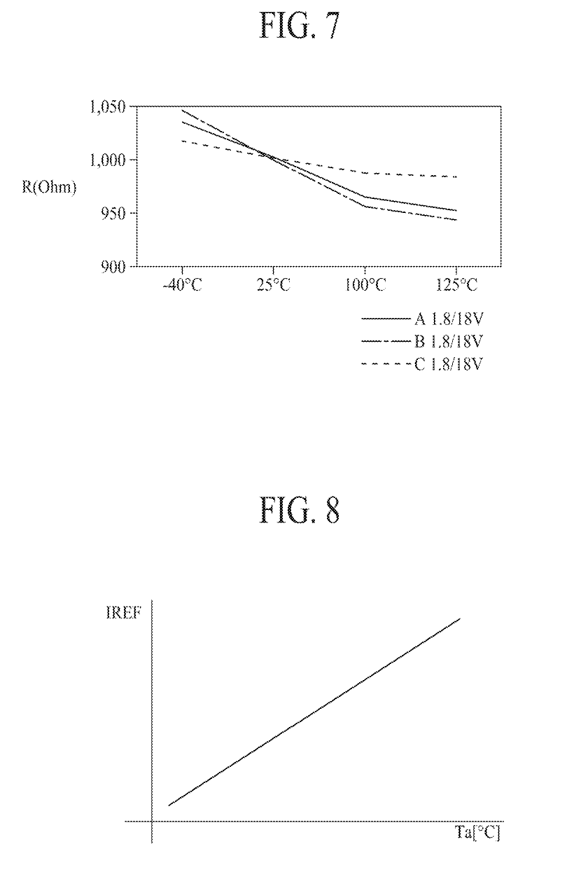

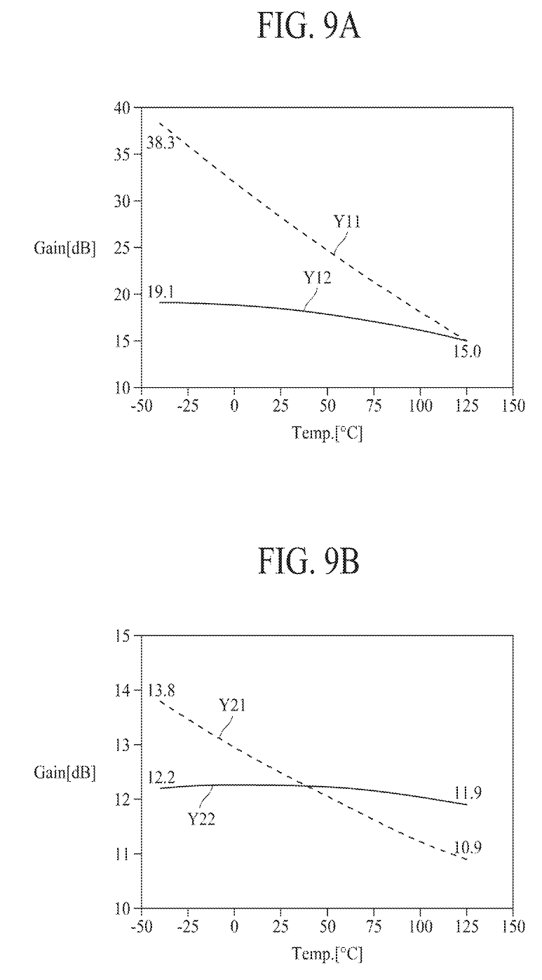

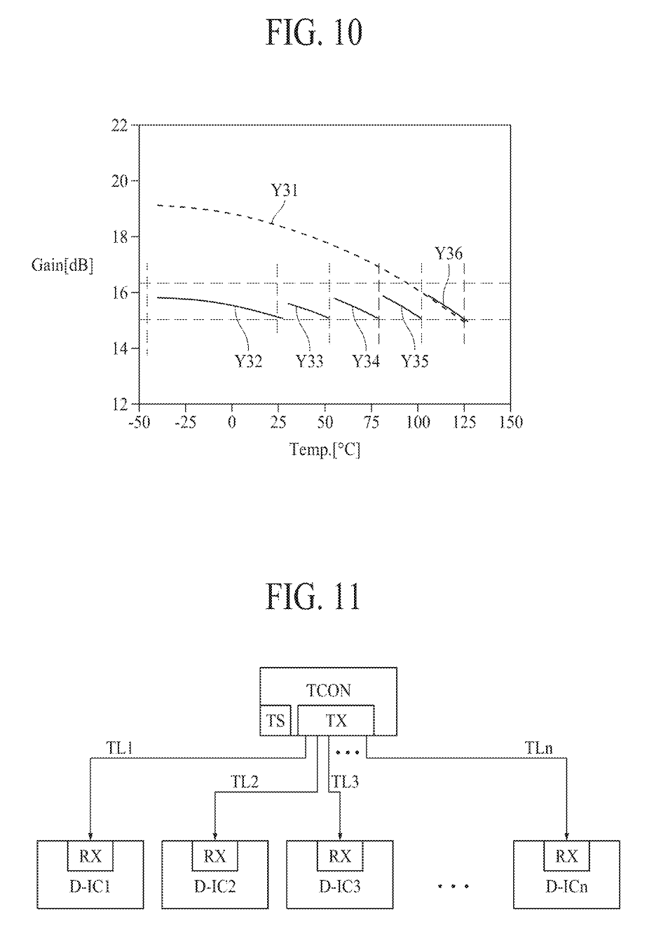

FIG. 5 is a graph illustrating a temperature-gain relationship of the amplifier according to one embodiment of the disclosure, FIG. 6 is a graph illustrating the frequency response characteristics and temperature relationship of the continuous time linear equalizer according to one embodiment of the present disclosure, FIG. 7 is a graph illustrating a temperature-resistance change rate of the P+ poly resistor in the temperature proportional voltage generation unit according to one embodiment of the present disclosure, for each process, FIG. 8 is a graph illustrating a temperature-current relationship of the temperature proportional voltage generation unit according to one embodiment of the present disclosure, FIGS. 9A and 9B are graphs illustrating a comparison of gain curves before and after compensation of the receiver circuit according to a comparative example and one embodiment of the present disclosure, and FIG. 10 is a graph illustrating a comparison of the gain curves of the receiver according to the comparative example and one embodiment of the present disclosure.

Referring to FIGS. 3, 5, and 6, it can be seen that the amplifier 126 has a characteristic in which the gain decreases as a temperature Ta increases, and the continuous time linear equalizer 124 has a characteristic in which the specific gain in the specific frequency band decreases as the temperature Ta increases.

Referring to FIGS. 4 and 7, it can be seen that the temperature variable resistor R2 using the P+ poly resistor in the temperature proportional voltage generation unit 23 has a characteristic in which the resistance value R decreases inversely proportional to the increase in temperature for each process even when formed in various processes A, B, and C. Accordingly, the temperature proportional voltage generation unit 23 may generate the temperature proportional current IPTAT which increases in proportion to the temperature Ta, that is, the temperature proportional voltage VPTAT.

Referring to FIGS. 3, 4, and 8, it can be seen that the variable reference current generation unit 122 increases the reference current IREF as the temperature Ta increases in response to the temperature compensation code TC of the temperature sensor 20. Accordingly, as the bias current of the continuous time linear equalizer 124 and the amplifier 126 increases to compensate for the gain reduction according to an increase in temperature, the gain change according to the temperature change may be suppressed or minimized.

Referring to FIG. 9A, the receiver according to the comparative example may use only a temperature compensation circuit which generates the temperature proportional current IPTAT. In this case, it can be seen that the amount of gain change according to the temperature change has decreased in a gain curve Y12 of the receiver according to the comparative example using the temperature compensation circuit of the temperature proportional current IPTAT, but the gain still decreases as the temperature increases compared to a gain curve Y11 in a case in which the temperature compensation circuit is not used. This is because the receiver according to the comparative example has a limitation in that it is not possible to compensate for a temperature change in resistor elements used in the amplifier and the continuous time linear equalizer even when the temperature compensation circuit of the temperature proportional current IPTAT is used.

Referring to FIGS. 3, 4, and 9B, the receiver 12 according to one embodiment may compensate for the gain reduction according to the temperature change using the temperature sensor 20 which detects the temperature change in addition to using the temperature proportional current IPTAT. Accordingly, it can be seen that a gain curve Y22 of the receiver 12 according to one embodiment is flattened as the amount of gain change according to the temperature change is minimized compared to a gain curve Y21 in the case where the temperature compensation circuit is not used and the gain curve Y11 according to the comparative example.

Referring to FIGS. 3, 4, and 10, it can be seen that a gain curve Y31 of the receiver using only the temperature compensation circuit according to the comparative example decreases significantly while the amount of gain change gradually decreases according to the temperature change.

On the other hand, it can be seen that the receiver 12 using the temperature sensor 20 according to one embodiment has different gain curves Y32, Y33, Y34, Y35, and Y36 according to a plurality of temperature ranges separated based on each of the plurality of reference temperatures (25° C, 50° C, 75° C, 100 ℃, and 125° C) by using the temperature compensation code TC according to the comparison result of the temperature proportional voltage VPTAT with the plurality of reference voltages VREF1 to VREF5.

Accordingly, it can be seen that the gain curves Y32, Y33, Y34, Y35, and Y36 of the receiver 12 using the temperature sensor 20 according to one embodiment may minimize the amount of gain change by discontinuously repeating decreases and increases in gain even when the temperature increases.

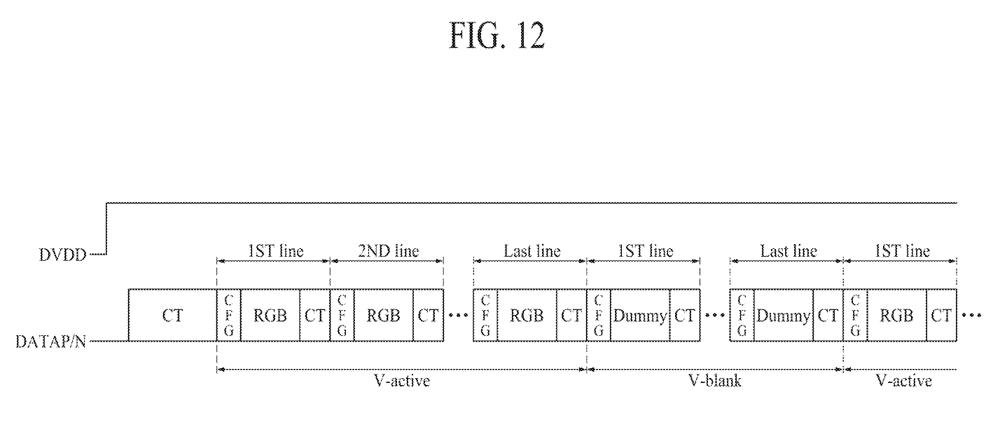

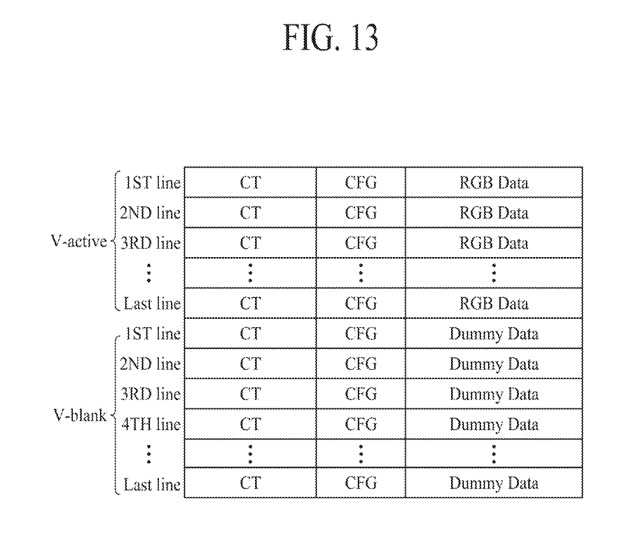

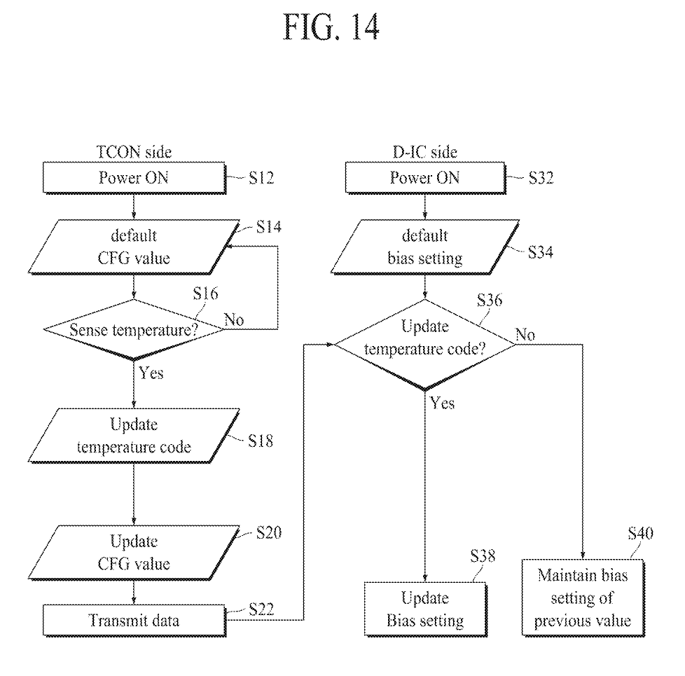

FIG. 11 is a block diagram schematically showing the display driving device according to one embodiment of the present disclosure, FIG. 12 is a waveform diagram illustrating a transmission packet of the display driving device according to one embodiment of the present disclosure, FIG. 13 is a view illustrating a data format of the display driving device according to one embodiment of the present disclosure, and FIG. 14 is a flowchart illustrating a temperature compensation method of the display driving device according to one embodiment of the present disclosure.

Referring to FIG. 11, the display driving device according to one embodiment may include a timing controller TCON and a plurality of data driving integrated circuits (ICs) D-IC1 to D-ICn.

In order to reduce the number of transmission lines and electromagnetic interference (EMI), the timing controller TCON and the plurality of data driving ICs D-IC1 to D-ICn of the display driving device may transmit and receive a transmission signal packet through a high-speed serial interface method of converting parallel data into serial data and transmitting the serial data in a point-to-point manner.

For a high-speed serial interface, the timing controller TCON may include a transmitter TX, each of the plurality of data driving ICs D-IC1 to D-ICn may include a receiver RX, and the transmitter TX and the plurality of receivers RX may be connected in a point-to-point manner through each of a plurality of transmission channels TL1 to TLn. The receiver RX of each of the plurality of data driving ICs D-IC1 to D-ICn may use the receiver 12 illustrated in FIGS. 2 and 3 described above.

The transmitter TX of the timing controller TCON may transmit the transmission packet in which serial data is converted into a differential signal such as a low voltage differential signal (LVDS), mini-LVDS, or the like to the receiver RX of each of the plurality of data driving ICs D-IC1 to D-ICn through each of the plurality of transmission channels TL1 to TLn. Each of the transmission channels TL1~TLn may include one pair of lines which transmits the transmission packet in the form of a differential signal, or a plurality of pairs of lines, for example, two or four pairs of lines. The transmitter TX may transmit serial transmission data in which a clock is embedded.

The timing controller TCON according to one embodiment may include a temperature sensor TS. The temperature sensor TS according to one embodiment may detect a temperature change using the temperature sensor 20 illustrated in FIG. 4 described above, and may generate and output the temperature compensation code TC. The timing controller TCON may include the temperature compensation code TC in the configuration information and transmit the temperature compensation code TC to the receiver RX of each of the plurality of data driving ICs D-IC1 to D-ICn.

The receiver RX of each of the plurality of data driving ICs D-IC1 to D-ICn may receive and use the equalizer setting value EQ[2:0] and the temperature compensation code TC from the timing controller TCON. Each receiver RX may have a gain of the continuous time linear equalizer corresponding to the equalizer setting value EQ[2:0]. Each receiver RX may vary (compensate for) the reference current IREF in response to the temperature compensation code TC, and amplify (compensate for) and output the received signals DATAP and DATAN in the form of differential signals using the compensated reference current IREF.

Referring to FIGS. 12 and 13, a serial transmission packet DATAP/N transmitted from the timing controller TCON to each of the driving ICs D-IC1 to D-ICn may include a clock training pattern CT, configuration information CFG, image data RGB, and a dummy pattern Dummy.

The clock training pattern CT may include a clock pattern for clock locking of a clock generation unit in the clock data recovery unit CDR of each of the plurality of data driving ICs D-IC1 to D-ICn. The configuration information CFG may include a plurality of data control signals which control the driving timing of the data driving ICs D-IC1 to D-ICn, and include the equalizer setting value EQ[2:0] and temperature compensation code TC described above.

After a power supply voltage DVDD of the display driving device is turned on, the timing controller TCON may transmit the clock training pattern CT during a first period, and the plurality of data driving ICs D-IC1 to D-ICn may generate a locked clock signal using the clock training pattern CT.

The timing controller TCON may transmit the configuration information CFG, the image data RGB, and the clock training pattern CT to the plurality of data driving ICs D-IC1 to D-ICn during each of a plurality of row line periods 1^{ST} line to Last line included in a vertical active period V-active of each frame. The timing controller TCON may also transmit the configuration information CFG, the dummy data Dummy, and the clock training pattern CT to the plurality of data driving ICs D-IC1 to D-ICn for each of the plurality of row line periods 1^{ST} line to Last line even during a vertical blank V-blank of each frame.

Each of the plurality of data driving ICs D-IC1 to D-ICn may recover and use the clock signal, the configuration information, and the image data from the transmission packet transmitted from the timing controller TCON.

The timing controller TCON may include the temperature compensation code TC in the configuration information CFG for each of the plurality of row line periods 1^{ST} line to Last line and transmit the temperature compensation code TC to the plurality of data driving ICs D-IC1 to D-ICn. Accordingly, the receiver RX of each of the plurality of data driving ICs D-IC1 to D-ICn may compensate for temperature-dependent changes in the received signal by adjusting the reference current in response to the received temperature compensation code TC for each row period and may compensate for transmission line loss and output the received signal.

Referring to FIGS. 11 and 14, in the display driving device according to one embodiment, the power of the timing controller TCON and the data driving ICs D-IC1 to D-ICn may be turned on (S12 and S32), and the timing controller TCON may set default configuration information (a default CFG value) (S14). The data driving ICs D-IC1 to D-ICn may also set a default bias current using default bias setting information.

The timing controller TCON may sense a temperature change using the temperature sensor TS included therein as described above (S16, Yes), and update the temperature compensation code TC in an internal register using the sensing result of the temperature change (S18).

The timing controller TCON may update the configuration information CFG of each row line using the updated temperature compensation code TC (S20), and transmit the transmission packet including the configuration information CFG, the image data RGB, and the clock training pattern CT of each row line to the data driving ICs D-IC1 to D-ICn (S22).

The receiver RX of each of the data driving ICs D-IC1 to D-ICn may recover the temperature compensation code TC from the configuration information CFG received from the timing controller TCON, and when the temperature compensation code TC is updated (S36, Yes), the bias current may be set by adjusting the reference current IREF according to the temperature compensation code TC (S38).

When the temperature compensation code TC is not updated (S36, No), the receiver RX of each of the data driving ICs D-IC1 to D-ICn may maintain the bias current setting of the previous state (S40).

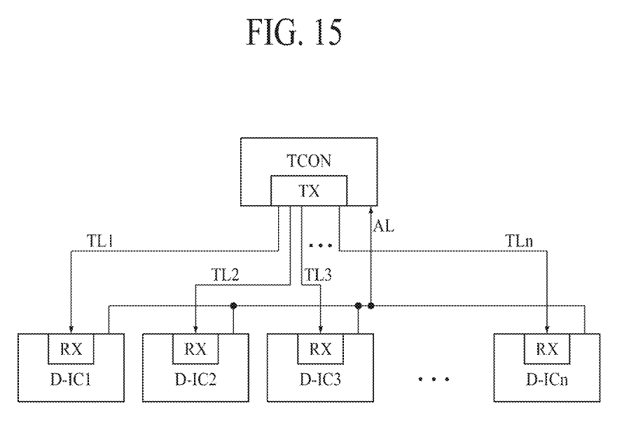

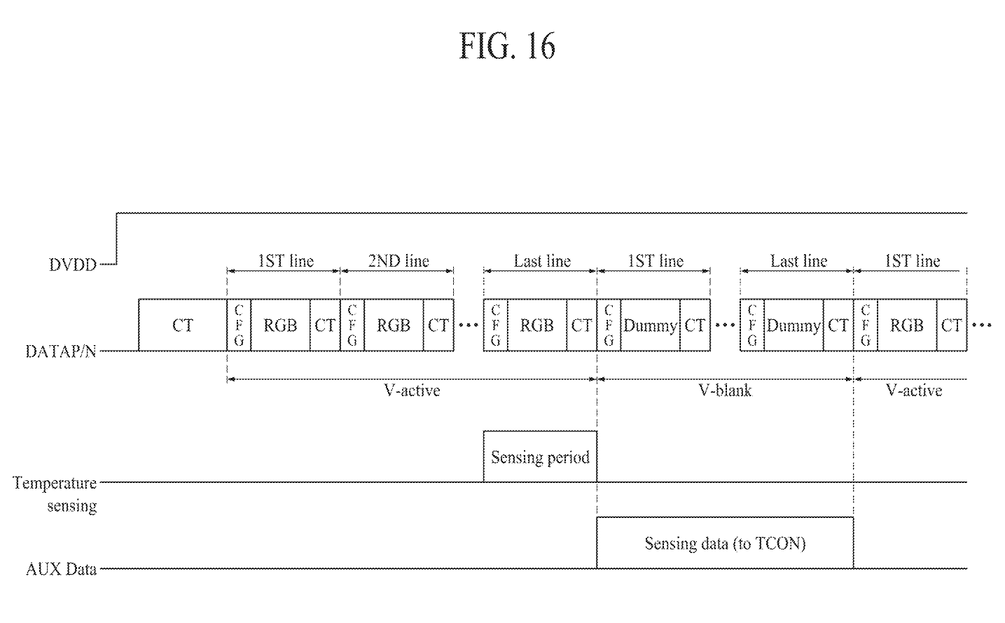

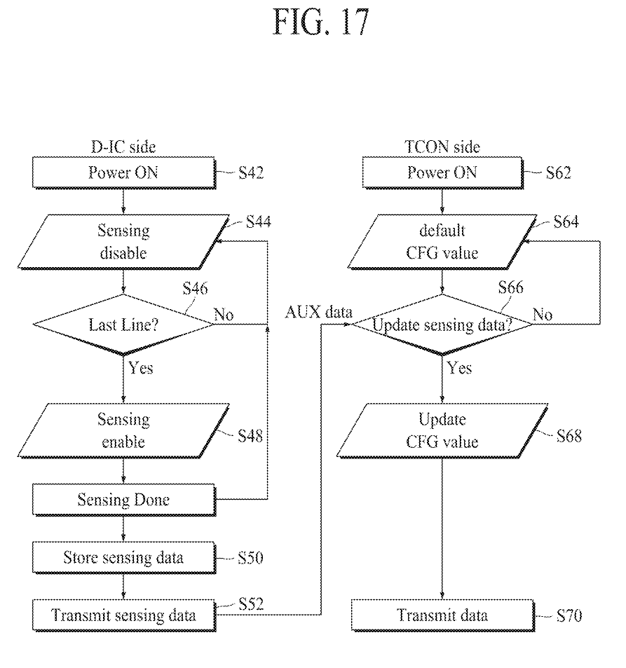

FIG. 15 is a block diagram schematically showing a display driving device according to one embodiment of the present disclosure, FIG. 16 is a waveform diagram illustrating a transmission packet of the display driving device according to one embodiment of the present disclosure, and FIG. 17 is a flowchart illustrating a temperature compensation method of the display driving device according to one embodiment of the present disclosure.

Since the display driving device according to one embodiment illustrated in FIG. 15 may additionally include an auxiliary transmission channel AL between the timing controller TCON and the plurality of data driving ICs D-IC1 to D-ICn, and has a difference in that the temperature sensor embedded in at least one of the plurality of data driving ICs D-IC1 to D-ICn senses a temperature and transmits the sensing data to the timing controller TCON compared to the display driving device according to one embodiment illustrated in FIG. 11, hereinafter, the following description will focus on differences from FIG. 11.

Referring to FIGS. 15 and 16, the receiver RX of each of the plurality of data driving ICs D-IC1 to D-ICn may include the temperature sensor and sense a temperature change. The receiver RX may sense a temperature change at least during the last row period of the vertical active period V-active and transmit the temperature change to the timing controller TCON through the auxiliary transmission channel AL during the vertical blank period V-blank.

The timing controller TCON may update the temperature compensation code TC using temperature sensing information transmitted from at least one of the plurality of data driving ICs D-IC1 to D-ICn. The timing controller TCON may include the updated temperature compensation code TC in the configuration information CFG and transmit the updated temperature compensation code TC to the receiver RX of each of the plurality of data driving ICs D-IC1 to D-ICn during each of the plurality of row line periods 1^{ST} line to Last line. Each receiver RX may vary (compensate for) the reference current IREF in response to the temperature compensation code TC, and amplify (compensate for) and output the received signals DATAP and DATAN in the form of differential signals using the compensated reference current IREF.

Referring to FIGS. 15 - 17, in the display driving device according to one embodiment, the power of the timing controller TCON and the data driving ICs D-IC1 to D-ICn may be turned on (S42 and S62), and the data driving ICs D-IC1 to D-ICn may maintain temperature sensing in a disabled state until a transmission period of the last row line during the vertical active period V-active (S44 and S46, No). The timing controller TCON may set the default configuration information (the default CFG value) (S64).

When the data driving ICs D-IC1 to D-ICn reach the transmission period of the last row line during the vertical active period V-active (S46, Yes), the temperature sensing may be changed to an enabled state (S48). The data driving ICs D-IC1 to D-ICn may sense a temperature change through the temperature sensor to complete temperature sensing (S49) and store the sensing data in the internal register (S50). The data driving ICs D-IC1 to D-ICn may transmit the sensing data to the timing controller TCON through the auxiliary transmission channel AL during the vertical blank period V-blank (S52).

The timing controller TCON may update the temperature compensation code TC in the internal register using the temperature sensing data transmitted from at least one of the data driving ICs D-IC1 to D-ICn (S66).

The timing controller TCON may update the configuration information CFG of each row line using the updated temperature compensation code TC (S68), and transmit the transmission packet including the configuration information CFG, the image data RGB, and the clock training pattern CT of each row line to the data driving ICs D-IC1 to D-ICn (S70). Accordingly, the receiver RX of each of the data driving ICs D-IC1 to D-ICn may recover the temperature compensation code TC from the configuration information CFG received from the timing controller TCON, and set the bias current by adjusting the reference current IREF according to the temperature compensation code TC.

As described above, the receiver according to one embodiment of the present disclosure may maintain constant compensation performance even in temperature changes and stably compensate for the received signal by compensating for the temperature change characteristics of the amplifier and the equalizer using the temperature sensor along with the temperature proportional current source.

The display driving device according to one embodiment of the present disclosure may accurately recover the received signal and enhance stability and reliability as the equalizer maintains constant compensation performance even in temperature changes using the temperature sensing information on the timing controller or the data driving circuit.

The data driving circuit according to one embodiment and the display driving device having the same may be applied to various electronic devices. For example, the data driving circuit according to one embodiment and the display driving device having the same may be applied to a mobile device, a video phone, a smart watch, a watch phone, a wearable device, a foldable device, a rollable device, a bendable device, a flexible device, a curved device, an electronic notebook, an electronic book, a portable multimedia player (PMP), a personal digital assistant (PDA), an MP3 player, a mobile medical device, a desktop personal computer (PC), a laptop PC, a netbook computer, a workstation, a navigation, a vehicle navigation, a vehicle display device, a television, a wallpaper display device, a signage device, a gaming device, a notebook, a monitor, a camera, a camcorder, a home appliance, and the like.

A receiver according to one embodiment of the present disclosure can maintain constant compensation performance even in temperature changes and stably compensate for a received signal by compensating for the temperature change characteristics of an amplifier and an equalizer using a temperature sensor along with a temperature proportional current source.

A display driving device according to one embodiment of the present disclosure can accurately recover the received signal and enhance stability and reliability as an equalizer maintains constant compensation performance even in temperature changes using temperature sensing information on a timing controller or a data driving circuit.

Features, structures, effects, and the like described in the various examples of the present specification described above are included in at least one example of the present specification and are not necessarily limited to only one example. Furthermore, the features, the structures, the effects, and the like exemplified in at least one example of the present specification may be combined or modified for other examples by those skilled in the art. Accordingly, contents related to these combinations and modifications should be interpreted as being included in the technical scope or scope of rights of the present specification.

It is apparent to those skilled in the art that the present specification described above is not limited to the above-described embodiments and accompanying drawings, and various substitutions, modifications, and changes are possible within the scope not departing from the technical spirit of the present specification. Accordingly, the scope of the present specification is defined by claims described below, and all modifications or variations derived from the meaning and scope of the claims and the equivalents should be interpreted as being included in the scope of the present specification.

What is claimed is:

1. A receiver comprising:
a continuous time linear equalizer and an amplifier configured to compensate for and amplify an input received signal and output the received signal, wherein a gain of the continuous time linear equalizer and the amplifier decreases with temperature;
a reference current generation unit configured to generate a reference current and provide the reference current as a bias current of the continuous time linear equalizer and the amplifier; and
a temperature sensor configured to sense a temperature by comparing a temperature proportional voltage generated using a temperature proportional current source with a plurality of reference voltages, and output a temperature compensation code using the temperature sensing result,
wherein the reference current generation unit is configured to adjust the reference current in response to the temperature compensation code from the temperature sensor.

2. The receiver of claim 1, wherein the reference current generation unit is configured to increase the reference current and the bias current in response to the temperature compensation code as the temperature sensed by the temperature sensor increases.

3. The receiver of claim 1, wherein the reference current generation unit is configured to increase the gain of the continuous time linear equalizer and the amplifier in response to the temperature compensation code as the temperature sensed by the temperature sensor increases.

4. The receiver of claim 3, wherein the temperature sensor includes:
a temperature proportional voltage generation unit configured to generate the temperature proportional voltage using the temperature proportional current source;
a reference voltage generation unit configured to generate a plurality of different reference voltages corresponding to each of a plurality of different reference temperatures using a fixed current source;
a comparison unit including a plurality of comparators configured to respectively compare the temperature proportional voltage with the plurality of reference voltages and output the comparison result; and
an encoder configured to encode the comparison result of the plurality of comparators and output the temperature compensation code.

5. The receiver of claim 4, comprising a plurality of gain curves separated from each other based on each of the reference temperatures,
wherein each of the plurality of gain curves has a form in which a corresponding gain decreases as a temperature belonging to a corresponding temperature range increases.

6. The receiver of claim 4, wherein the plurality of reference voltages decrease as the plurality of reference temperatures increase.

7. The receiver of claim 4, wherein the reference voltage generator further comprises:
a plurality of resistors connected in series with the fixed current source and configured to respectively generate the plurality of reference voltages inversely proportional to the plurality of reference temperatures.

8. The receiver of claim 4, wherein the temperature-proportional voltage generator further comprises:
a temperature-variable resistor connected in series with the temperature-proportional current source and configured to generate the temperature-proportional voltage based on a characteristic in which a resistance value of the temperature-variable resistor decreases in proportion to the temperature.

9. A display driving device comprising:
a timing controller that transmits a transmission packet including a clock training pattern, configuration information, and image data; and
first and second data driving circuits that receive the transmission packet from the timing controller and recover and use a clock signal, the configuration information, and the image data from a received signal,
wherein the timing controller further includes a temperature sensor that senses a temperature, generates a temperature compensation code from an output of the temperature sensor, includes the temperature compensation code in the configuration information, and transmits the temperature compensation code to each of the first and second data driving circuits, and
a receiver of each of the first and second data driving circuits is configured to compensate for a gain of the receiver in response to the temperature compensation code included in the configuration information.

10. The display driving device of claim 9, wherein the receiver includes:
a continuous time linear equalizer and an amplifier configured to compensate for and amplify the received signal and output the received signal, and allow the gain to decrease according to temperature; and
a reference current generation unit configured to generate a reference current and provide the reference current as a bias current of the continuous time linear equalizer and the amplifier, and
the reference current generation unit is configured to adjust the reference current in response to the temperature compensation code.

11. The display driving device of claim 10, wherein the reference current generation unit is configured to increase the reference current and the bias current in response to the temperature compensation code as the temperature sensed by the temperature sensor increases.

12. The display driving device of claim 10, wherein the receiver is configured to adjust the reference current and the bias current when the temperature compensation code is updated.

13. The display driving device of claim 9, wherein the timing controller includes the temperature compensation code in the configuration information and transmits the temperature compensation code for each period of each row line during a vertical active period of each frame.

14. A display driving device comprising:
a timing controller that transmits a transmission packet including a clock training pattern, configuration information, and image data; and
a data driving circuit that receives the transmission packet from the timing controller and recovers and uses a clock signal, the configuration information, and the image data from a received signal,
wherein the data driving circuit further includes a temperature sensor that senses a temperature, and transmits sensing data of the temperature sensor to the timing controller through an auxiliary channel,
the timing controller generates a temperature compensation code from the sensing data, includes the temperature compensation code in the configuration information, and transmits the temperature compensation code to the data driving circuit, and
a receiver of the data driving circuit is configured to compensate for a gain of the receiver in response to the temperature compensation code included in the configuration information.

15. The display driving device of claim 14, wherein the receiver includes:
a continuous time linear equalizer and an amplifier configured to compensate for and amplify the received signal and output the received signal, and allow the gain to decrease according to temperature; and
a reference current generation unit configured to generate a reference current and provide the reference current as a bias current of the continuous time linear equalizer and the amplifier, and
the reference current generation unit is configured to adjust the reference current in response to the temperature compensation code.

16. The display driving device of claim 15, wherein the reference current generation unit is configured to increase the reference current in response to the temperature compensation code as the temperature sensed by the temperature sensor increases.

17. The display driving device of claim 15, wherein the receiver is configured to adjust the reference current and the bias current when the temperature compensation code is updated.

18. The display driving device of claim 14, wherein the data driving circuit enables the temperature sensor during one row line period during a vertical active period of each frame to generate the sensing data, and
transmits the sensing data to the timing controller during a vertical blank period of each frame.

19. The display driving device of claim 14, wherein the timing controller includes the temperature compensation code in the configuration information and transmits the temperature compensation code for each period of each row line during a vertical active period of each frame.
